(19) United States
(12) Patent Application Publication
(10) Pub. No.: US 2018/0169961 A1
(43) Pub. Date: Jun. 21, 2018

(54) SYSTEM AND METHOD FOR BONDING STRUCTURES

(71) Applicant: GM GLOBAL TECHNOLOGY OPERATIONS LLC, Detroit, MI (US)

(72) Inventors: Matthew P. Simonin, Ortonville, MI (US); Charles E. Jensen, Shelby Township, MI (US); Joseph M. Polewarczyk, Rochester Hills, MI (US)

(73) Assignee: GM GLOBAL TECHNOLOGY OPERATIONS LLC, Detroit, MI (US)

(21) Appl. No.: 15/380,298

(22) Filed: Dec. 15, 2016

(51) Int. Cl. B29C 65/48; B29C 65/02

(52) U.S. Cl. CPC B29C 65/48; B29L 2031/30; B29C 65/02

(57) ABSTRACT

A system and method for bonding structures includes a method of bonding a first panel to a second panel. An adhesive material is applied to at least one of the first panel and the second panel and is disposed between the first panel and the second panel. A welding device having at least a first electrode and a second electrode is configured to receive and position the first panel and second panel between the first and second electrodes. The welding device generates an electric current with the first and second electrodes to apply to the first panel and the second panel. The electric current generates thermal energy having a first temperature that cures the adhesive material positioned between the first and second electrodes to bond the first panel with the second panel.

### INTRODUCTION

The present disclosure relates to a system and method for bonding structures.

Automotive body panels are typically formed of metals, and are joined together by welding. Welding is a manufacturing or fabrication process that bonds materials such as metals or thermoplastics by causing coalescence, a process by which two separate units grow together, fuse, or merge into a single body. The materials are joined by liquefying or plasticizing the areas to be bonded together, generally through the application of heat and/or pressure over time, promoting coalescence of the liquefied or plasticized material, and allowing the coalesced material to cool, thereby solidifying the bond.

Composite materials such as fiberglass are favored in certain manufacturing settings for their high strength and lightweight properties. Composite panels are typically joined together with adhesive applied to mating flanges. Alternatively, composite materials may be joined by mechanical fasteners, such as bolts and rivets.

### SUMMARY

A system and method for bonding structures includes a method of bonding a first panel to a second panel. The method includes applying an adhesive material to at least one of the first panel and the second panel and positioning the first panel on the second panel such that the adhesive material is disposed between the first panel and the second panel. A welding device having at least a first electrode and a second electrode is configured to receive and position the first panel and second panel between the first and second electrodes such that the first electrode is proximate the first panel and the second electrode is proximate the second panel.

The welding device generates an electric current with the first and second electrodes to apply to the first panel and the second panel. The electric current generates thermal energy having a first temperature that cures the adhesive material positioned between the first and second electrodes to bond the first panel with the second panel.

The method additionally includes contacting the first panel with the first electrode and the second panel with the second electrode and applying a force to at least one of the first and second electrodes that is operative to clamp the first panel and second panel between the first and second electrodes. The first panel may be formed from a first material and the second panel may be formed from a second material. The first material may be a metal and the second material is a non-metal, or the first and second materials may both be metals or polymers.

The thermal energy is generated between the first and second electrodes of the welding device at a first temperature. The first temperature of the thermal energy generated between the first and second electrodes of the welding device is determined based upon one or more of the materials used to form the first panel, the second panel and the adhesive material. The welding device may be a resistance spot welding device.

In another embodiment, a system for assembling a bonded structure includes a first panel formed from a first material and a second panel made of a second material. An adhesive material is applied to at least one of the first panel and the second panel. A welding device having at least a first electrode and a second electrode is configured to cure the adhesive material positioned between the first and second electrodes to bond the first panel with the second panel.

The welding device positions the first panel and second panel between the first and second electrodes such that the first electrode is proximate the first panel and the second electrode is proximate the second panel and contacts the first panel with the first electrode and the second panel with the second electrode. An electric current is generated by the first and second electrodes to generate thermal energy having a first temperature that cures the adhesive material positioned between the first and second electrodes to bond the first panel with the second panel.

The first and second electrodes are operatively connected to apply a force to the first panel and the second panel when positioned between the first and second electrodes. The thermal energy is generated between the first and second electrodes of the welding device at a first temperature. The first temperature of the thermal energy generated between the first and second electrodes of the welding device is determined based upon one or more of the materials used to form the first panel, the second panel and the adhesive material. The welding device may be a resistance spot welding device.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is an enlarged cross-sectional view of components of a pre-bonded structure in accordance with the present disclosure;

FIG. 2 is a side elevational view of the structure positioned relative to a welding device for use in the present disclosure; and

FIG. 3 is flowchart detailing the method of bonding structures in accordance with the present disclosure.

### DETAILED DESCRIPTION

Reference will now be made in detail to several embodiments of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity, directional terms such as top, bottom, left, right, up, over, above, below, beneath, rear, and front, may be used with respect to the drawings. These and similar directional terms are not to be construed to limit the scope of the disclosure.

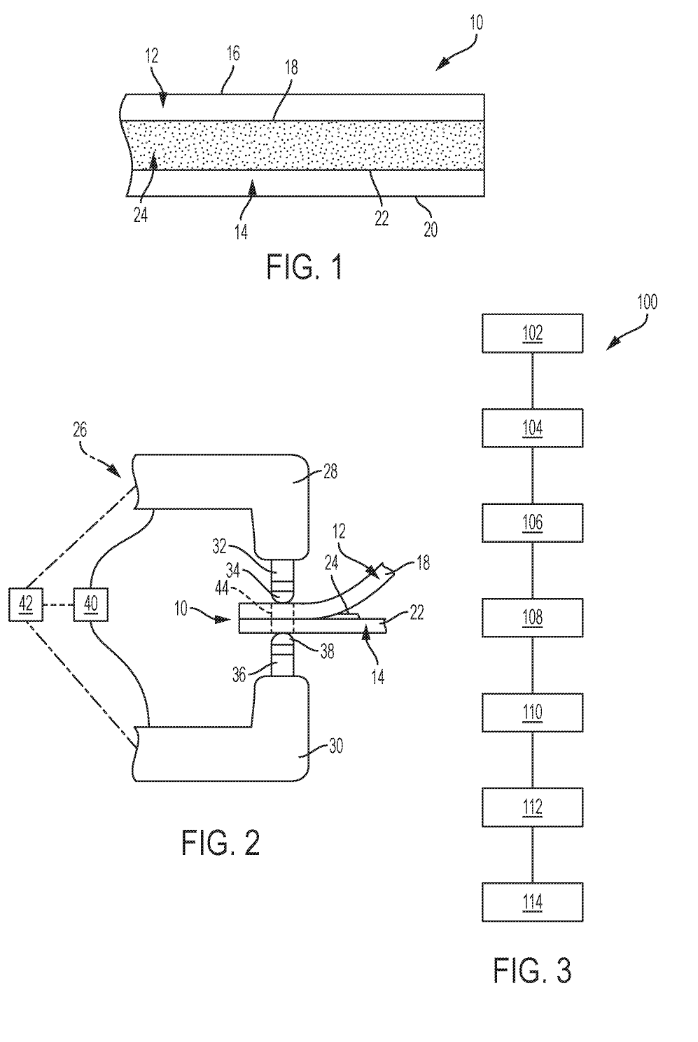

Referring to the drawings, wherein like reference numbers correspond to like or similar components throughout the several Figures, a structure is generally shown at 10. Referring to FIG. 1, the structure 10 is shown in a pre-bonded state and includes a first sheet or panel 12 composed of a first material and a second panel 14 composed of a second material that is operatively connected to the first panel 12. It is understood that the first and second materials of the first panel 12 and second panel 14 may be similar materials, such as both formed from metals or formed from polymers, or may be formed from dissimilar materials, including, but not limited to the first panel being formed from metal while the second panel is formed from a non-metal such as thermoplastics or the like or formed from a distinct metal from the metal selected for the first panel.

As show in the Figures, the first and second panels 12, 14 may be vehicle body panels such as the inner and outer panels of a vehicle door, fender, hood and the like. In one non-limiting example, panels 12, 14 may be formed from a fiber-reinforced composite material that may include a plurality of unidirectional or multi-directional fibers disposed within an epoxy or resinous matrix or substrate. The fibers may include spun glass fibers, carbon fibers, graphite fibers or other suitable high-tensile strength fiber materials.

It should be noted that the first and second panels 12, 14 may comprise any material and may be used for any purpose within the scope of the disclosure. For example, the first panel may be formed from steel such as a galvanized low carbon steel or a galvanized high strength steel while the second panel is formed from an aluminum alloy or the like. It is also contemplated that one or more of the materials may be coated with a conversion coating to improve the adhesive bond performance. It is also understood that the system and method described herein may be used in more than one plane to bond structures. Put another way, the system and method may be used in multiple planes and locations to geo-set parts or structures.

The first panel 12 includes an exterior surface 16 and an opposing interior surface 18. The second panel 14 also includes an exterior surface 20 and an opposing interior surface 22. As will be described in greater detail below, it is contemplated that the exterior surfaces 16, 20 of the first and second panels 12, 14 may be engaged by one or more electrodes of the welding device while the interior surfaces 18, 22 of the first and second panels 12, 14 may be configured to cooperate with and be secured by adhesive materials 24 provided thereon.

With additional reference to FIG. 3, a flowchart detailing the method 100 for bonding the first and second panels of the structure is described in greater detail. The method 100 need not be applied in the specific order recited herein and it is further understood that one or more steps may be eliminated. The method begins at box or step 102, wherein an uncured adhesive material 24 is applied to one or more of the interior surfaces 18, 22 of the first and second panels 12, 14. The first and second panels 12, 14 and adhesive material 24 may be formed with any size, shape or thickness.

An adhesive material 24 is applied to at least one of the interior surfaces 18 of the first panel 12 and the interior surface 22 of the second panel 14 to bond together the first and second panels 12, 14. The adhesive material 24 may be applied to the first and second panels 12, 14 in an uncured or partially cured state. The adhesive material 24 may include an epoxy, a cyanoacrylate adhesive, a silicone adhesive, or another known adhesive. The adhesive material 24 may have a sufficiently low viscosity to evenly distribute itself between the top and base plates 16, 14 when the plates are brought into close contact. For example, the adhesive material 24 may be applied to one of the interior surface 18 of the first panel 12 or the interior surface 22 of the second panel 14 and then positioning the second panel 14 generally parallel relative to the first panel 12 to allow the panels 12, 14 to be bonded to each other by the adhesive 24.

At step or box 104, the interior surface 18 of the first panel 12 is positioned proximate to and against the interior surface 22 of the second panel 14. In this position, the adhesive material 24 is disposed between the first panel 12 and second panel 14 and provides an initial bond between the interior surface 18 of the first panel 12 and the interior surface 22 of the second panel 14. At step or box 106, a welding device 26 is provided and cooperates with the first and second panels 14 to assist in curing the adhesive material 24 therebetween.

Referring to FIG. 2, an exemplary welding device 26 is illustrated and described in greater detail. In one non-limiting embodiment, welding device 26 may be a resistance spot welder (RSW) or RSW gun that is part of an automated welding operation. Welding device 26 may include a first arm 28 and a second arm 30 that are mechanically and electrically configured to repeatedly form spot welds in accordance with a defined weld schedule. The first arm 28 of the welding device 26 may include a first electrode holder 32 that retains a first welding electrode 34, and the second arm 30 has a second electrode holder 36 that retains a second electrode 38. It is contemplated that the first and second electrodes 34, 38 may be formed of a variety of materials, including, but not limited to, steel, aluminum and the like.

At step or box 108, first and second panels 12, 14 of the structure 10 are positioned relative to the welding device 26. In one embodiment, the first and second arms 28, 30 of the welding device 26 are operable to position the respective first and second electrodes 36, 38 proximate the oppositely-facing exterior and electrode-contacting surfaces 16, 20 of the first and second panels 12, 14.

The welding device 26 is positioned adjacent the first and second panels 12, 14 to cure the adhesive material 24 disposed between the panels 12, 14 to bond the first and second panels 12, 14 together. It is contemplated that the weld device 26 may be utilized in other operations to join or fuse similar metallic panels with each other by using electrical resistance. As described herein, welding device 26 is utilized to adhere the first and second panels 12, 14 at one or more positions to complete the bonding process.

At block or step 110, the first and second welding electrodes 34, 38 may be pressed or clamped against their respective electrode-contacting surfaces 16, 20 in diametric alignment with one another. The gap or distance between the electrodes 34, 38 may be adjusted. Alternatively, the clamping load or force applied by the electrodes 34, 38 may be adjusted to compensate for the type of materials used for at least one of the first panel 12, second panel 14 and/or the adhesive material 24. For example, it is contemplated that a specified gap or clamping force or control may be desired in addition to control of the temperature, amount of time, or level of current to ensure proper curing of the adhesive material 24 between the first and second panels 12, 14.

At block or step 112, the welding device 26 generates an electric current with and is conducted through the first and second electrodes 34 and is applied to the first and second panels 12, 14. In one non-limiting example, an adjustable power source is in electrical communication with the welding device 26 to generate current to be passed between the first and second electrodes 34, 38. The welding device 26 may further include a controller 42 in electrical communication with the adjustable power source 40 and the first and second electrodes 34, 38 and configured to adjust the current applied by the electrodes 34, 38 to the first and second panels 12, 14.

The first and second electrodes 34, 38 may concentrate the current into a spot 44 on the structure 10. The current created by the first and second electrodes 34, 38 generates thermal energy or heat of at least a first temperature that interacts with the uncured or partially cured adhesive material 24 disposed between the first and second panels 12, 14 to cure the adhesive material 24 to bond or fuse the first and second panels 12, 14 at the spot 44 on structure 10.

The current generated with the first and second electrodes 34, 38 may be applied for a selected time and temperature in order to permit the bonding to occur without excessive heating to the first and second panels 12, 14 of the structure 10. The amount of heat or thermal energy delivered to the spot 44 is determined by the resistance between the first and second electrodes 34, 38 and the amperage and duration of the welding current. The amount of thermal energy and/or duration of the current is chosen to match the material properties and thicknesses of the material adhesive 24, the first panel 12 and the second panel as well as the types of electrodes used. The controller 42 may be utilized to adjust one or more of the time, current and temperature of the thermal energy used in the bonding process.

At step or box 114, the method cooling the bonded section of the structure 10 wherein the adhesive material 24 bonds the first panel 12 with the second panel 14 at spot 44 on the structure 10 to fuse the first and second panels 12, 14 together to complete the bonding process.

In another embodiment of the disclosure, a fastener (not shown) may be used to secure the first panel 12 to the second panel 14. The fastener may generally include a head portion abutting at least one exterior surface of the first panel 12 or the second panel 14 and a body portion that extends at least partially between the first and second panels 12, 14. When fully assembled, the head portion of the fastener may contact and may apply a compressive load to one or more of the first and second panels 12, 14 to aid in securing the first panel 12 to the second panel 14. It is contemplated that the fasteners may be used in combination with the bonding process and applied to the first and second panels 12, 14 either prior to or after completion of the bonding process.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

1. A method of bonding a first panel to a second panel, the method comprising:
applying an adhesive material to at least one of the first panel and the second panel;
positioning the first panel on the second panel such that the adhesive material is disposed between the first panel and the second panel;
positioning the first panel and second panel in between first and second electrodes of a welding device such that the first electrode is proximate the first panel and the second electrode is proximate the second panel; and
generating an electric current with the first and second electrodes to apply to the first panel and the second panel,
wherein the electric current generates thermal energy having a first temperature that cures the adhesive material positioned between the first and second electrodes to bond the first panel with the second panel.

2. The method of claim 1 further comprising:
contacting the first panel with the first electrode and the second panel with the second electrode; and
applying a force to at least one of the first and second electrodes that is operative to clamp the first panel and second panel between the first and second electrodes.

3. The method of claim 1 wherein the first panel is formed from a first material and the second panel is formed from a second material.

4. The method of claim 3 wherein the first material is a metal and the second material is a non-metal.

5. The method of claim 3 wherein the first and second materials are metal.

6. The method of claim 3 wherein the first and second materials are polymers.

7. The method of claim 1 wherein the thermal energy is generated between the first and second electrodes of the welding device at a first temperature.

8. The method of claim 7 wherein the first temperature of the thermal energy generated between the first and second electrodes of the welding device is determined based upon one or more of the materials used to form the first panel, the second panel and the adhesive material.

9. The method of claim 1 wherein the welding device further comprises a resistance spot welding gun.

10. A method of bonding a first panel formed from a first material to a second panel formed from a second material, the method comprising:
applying an adhesive material to at least one of the first panel and the second panel;
positioning the first panel on the second panel such that the adhesive material is disposed between the first panel and the second panel;
providing a welding device having at least a first electrode and a second electrode;
positioning the first panel and second panel between the first and second electrodes such that the first electrode is proximate the first panel and the second electrode is proximate the second panel;
contacting the first panel with the first electrode and the second panel with the second electrode; and
generating an electric current with the first and second electrodes to apply to the first panel and the second panel,
wherein the electric current generates thermal energy having a first temperature that cures the adhesive material positioned between the first and second electrodes to bond the first panel with the second panel.

11. The method of claim 10 further comprising applying a force to at least one of the first and second electrodes that is operative to clamp the first panel and second panel between the first and second electrodes.

12. The method of claim 10 wherein the first material is a metal and the second material is a non-metal.

13. The method of claim 10 wherein the thermal energy is generated between the first and second electrodes of the welding device at a first temperature.

14. The method of claim 13 wherein the first temperature of the thermal energy generated between the first and second electrodes of the welding device is determined based upon one or more of the materials used to form the first panel, the second panel and the adhesive material.

15. The method of claim 10 wherein the welding device further comprises a resistance spot welding device.

16. A system for assembling a bonded structure comprising:
a first panel formed from a first material;
a second panel made of a second material;
an adhesive material applied to at least one of the first panel and the second panel; and
a welding device having at least a first electrode and a second electrode configured to cure the adhesive material positioned between the first and second electrodes to bond the first panel with the second panel,
wherein the welding device,
positions the first panel and second panel between the first and second electrodes such that the first electrode is proximate the first panel and the second electrode is proximate the second panel,
contacts the first panel with the first electrode and the second panel with the second electrode, and
generates an electric current with the first and second electrodes to generate thermal energy having a first temperature that cures the adhesive material positioned between the first and second electrodes to bond the first panel with the second panel.

17. The system of claim 16 wherein the first and second electrodes are operatively connected to apply a force to the first panel and the second panel when positioned between the first and second electrodes.

18. The system of claim 16 wherein the thermal energy is generated between the first and second electrodes of the welding device at a first temperature.

19. The system of claim 16 wherein the first temperature of the thermal energy generated between the first and second electrodes of the welding device is determined based upon one or more of the materials used to form the first panel, the second panel and the adhesive material.

20. The system of claim 16 wherein the welding device further comprises a resistance spot welding device.
